(19) United States
(12) Patent Application Publication
(10) Pub. No.: US 2025/0229559 A1
(43) Pub. Date: Jul. 17, 2025

(54) PRINTING DEVICE

(71) Applicant: TOSHIBA TEC KABUSHIKI KAISHA, Tokyo (JP)

(72) Inventors: Masakazu KATO, Numazu Shizuoka (JP); Sadatoshi OISHI, Fuji Shizuoka (JP)

(73) Assignee: TOSHIBA TEC KABUSHIKI KAISHA, Tokyo (JP)

(21) Appl. No.: 18/991,299

(22) Filed: Dec. 20, 2024

(30) Foreign Application Priority Data
Jan. 12, 2024 (JP) 2024-003241

(51) Int. Cl. B41J 33/60; B41J 2/325; B41J 3/407; B41J 33/00; B41J 33/16; B41J 35/38; G06K 7/10

(52) U.S. Cl. CPC B41J 33/60; B41J 2/325; B41J 3/4075; B41J 33/003; B41J 33/16; B41J 35/38; G06K 7/10366

(57) ABSTRACT

Provided is a printing device capable of performing data communication with a wireless tag provided on a holder that holds a medium used for printing. The printing device can include a shaft, an antenna, a reader, and a controller. The shaft rotatably supports a medium roll configured to have the medium wound around a cylindrical body provided with the wireless tag. The antenna wirelessly communicates with the wireless tag. The reader reads data recorded in the wireless tag by wireless communication via the antenna. The controller causes the reader to perform a second read of the data in the wireless tag after the cylindrical body has been rotated around the shaft for a first rotation time and then has been stopped in response to the reader being unable to read the data recorded in the wireless tag.

### CROSS-REFERENCE TO RELATED APPLICATION

This application is based upon and claims the benefit of priority from Japanese Patent Application No. 2024-003241, filed on Jan. 12, 2024, the entire contents of which are incorporated herein by reference.

### FIELD

Embodiments described herein relate to a printing device.

### BACKGROUND

A thermal printer such as a label printer performs printing by superimposing an ink ribbon on a printing sheet and transferring an ink of the ink ribbon to the printing sheet using a thermal head. The thermal printer may perform printing control settings such as a printing speed according to a type of the used ink ribbon. A thermal printer in the related art performs printing control settings based on data read from a wireless tag provided on a ribbon roll around which an ink ribbon is wound.

However, a reader writer provided in the thermal printer may not read the data from the wireless tag according to a positional relationship between an antenna and the wireless tag which is provided on the ribbon roll. Therefore, there is a demand for a printing device such as a thermal printer to perform data reading processing of reliably reading the data of the wireless tag provided on the ribbon roll.

### DESCRIPTION OF THE DRAWINGS

FIG. 1 is a diagram illustrating a schematic configuration of a label printer as a printing device according to an embodiment;

FIG. 2 is a partially enlarged perspective view illustrating main parts of a feeding shaft;

FIG. 3 is an exploded perspective view of the feeding shaft;

FIG. 4 is a block diagram illustrating an example of a control system;

FIG. 5 is a perspective view illustrating a paper tube of a ribbon roll provided with a wireless tag and attached to the feeding shaft;

FIG. 6 is a perspective view illustrating a paper tube of a ribbon roll provided with a wireless tag;

FIG. 7 is a diagram illustrating examples of results of reading data from the wireless tags according to a positional relationship between the wireless tags and an antenna;

FIG. 8 is a schematic diagram illustrating a state in which an angle between the wireless tag and the antenna is 0 degrees;

FIG. 9 is a schematic diagram illustrating a state in which an angle between the wireless tag and the antenna is 90 degrees;

FIG. 10 is a diagram illustrating a setting example of a rotation time of the paper tube provided with the wireless tag and a processing time of data reading processing on the wireless tag;

FIG. 11 is a diagram illustrating a setting example of the rotation time of the paper tube;

FIG. 12 is a flowchart illustrating a first operation example of the data reading processing; and

FIG. 13 is a flowchart illustrating a second operation example of the data reading processing.

### DETAILED DESCRIPTION

In general, according to one embodiment, an object of an exemplary embodiment is to provide a printing device capable of performing good data communication with a wireless tag provided on a holder that holds a medium used for printing.

According to an embodiment, the printing device includes a shaft, an antenna, a reader, and a controller. The shaft rotatably supports the medium roll in which the medium is wound around a cylindrical body provided with the wireless tag. The antenna wirelessly communicates with the wireless tag provided on the cylindrical body supported by the shaft. The reader reads data recorded in the wireless tag by wireless communication via the antenna. The controller causes the reader to read again the data recorded in the wireless tag in a state in which the cylindrical body is rotated around the shaft for any rotation time and then is stopped when the reader is unable to read the data recorded in the wireless tag by the wireless communication via the antenna.

Hereinafter, an embodiment will be described with reference to the drawings. In the drawings used in the following description, a scale of each part may be appropriately changed. In the drawings, configurations may be simplified or omitted for easy understanding of the description.

First, a configuration example of a label printer 100 as a printing device according to the embodiment will be described.

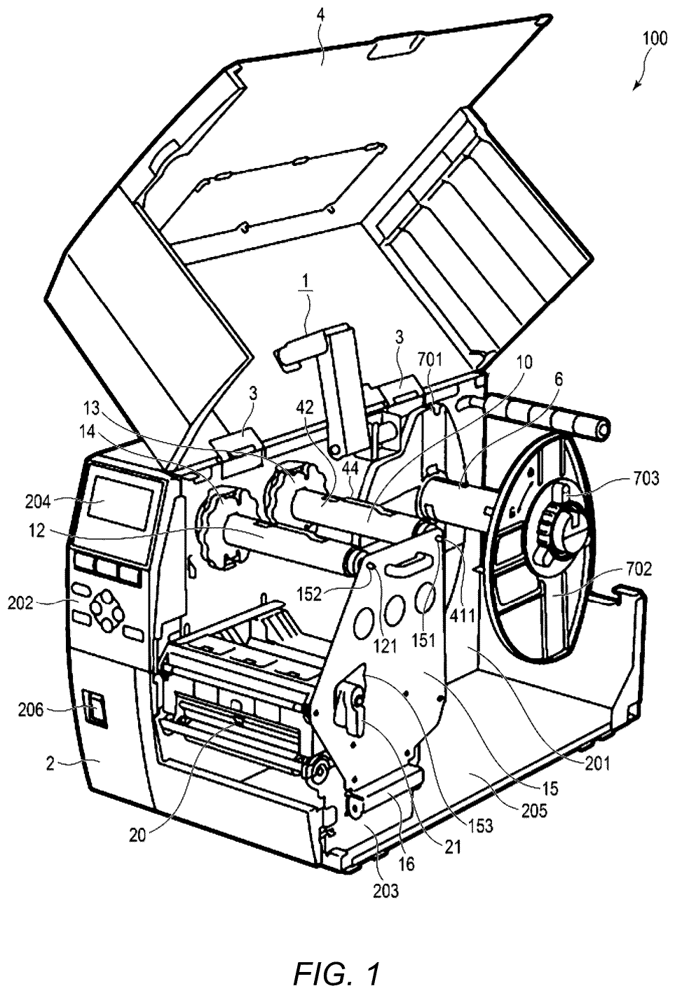

FIG. 1 is a schematic diagram illustrating a label printer 100 as a printing device according to the embodiment.

As illustrated in FIG. 1, the label printer 100 includes a housing 2 and a cover 4. The cover 4 is pivotably connected to the housing 2 via two hinges 3. The cover 4 is pivotable between an open position illustrated in FIG. 1 at which an interior of the housing 2 is opened and a closed position at which the interior of the housing 2 is covered. A damper 1 for smoothing an opening and closing operation of the cover 4 is provided between the cover 4 and the housing 2. The label printer 100 has a substantially rectangular block-shaped outer shape when the cover 4 is closed.

An operation unit 202, a display unit 204, and a power switch 206 are provided on a front surface of the housing 2. The operation unit 202 is an input device (a touch panel, operation keys, or the like) through which a user inputs an operation instruction. The operation unit 202 provides inputs for, for example, information on label sheets, the number of sheets to be printed, and the like for the user to input. The display unit 204 is a display device that displays information. The display unit 204 displays, for example, operation information, an operation menu, and the like. The power switch 206 is a switch for turning on or off the label printer 100.

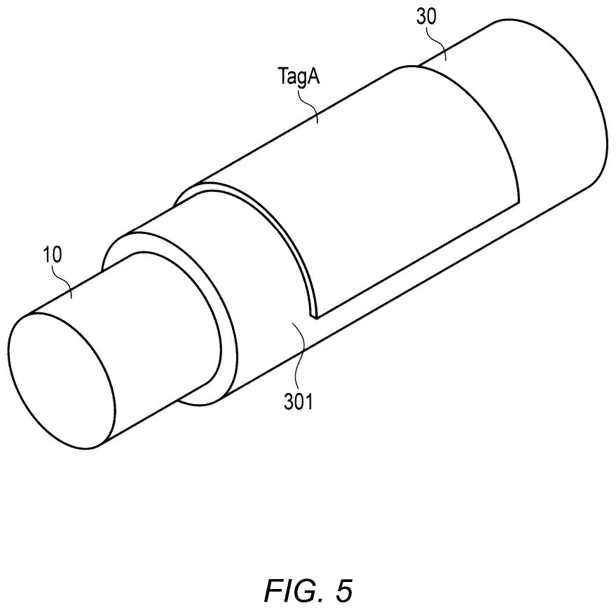

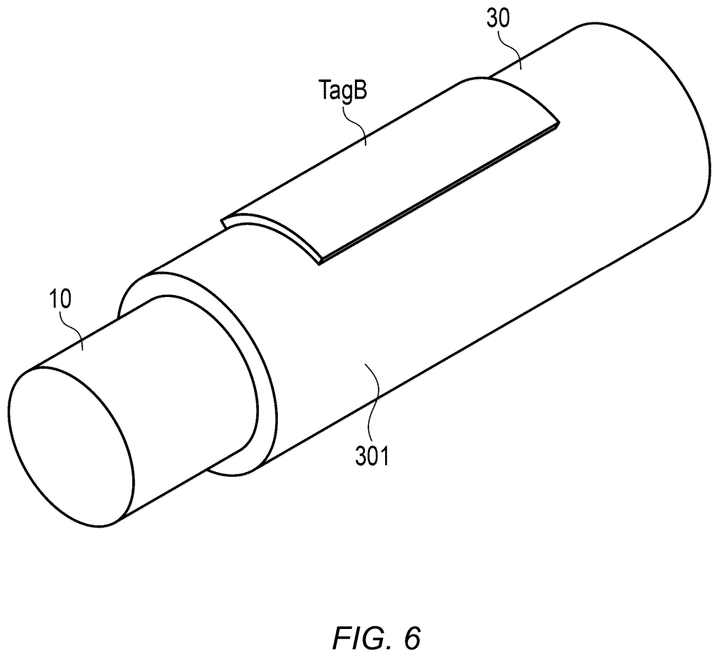

The label printer 100 includes a supply shaft 6, a feeding shaft (shaft) 10, a winding shaft 12, and a printing unit 20 (e.g., printer). A label sheet roll is attached to the supply shaft 6. A ribbon roll in which an ink ribbon before use is wound around a paper tube 30 (see FIGS. 5 and 6) is detachably attached to the feeding shaft 10. The supply shaft 6 and the feeding shaft 10 are examples of a shaft that supports a medium roll (e.g., the ribbon roll, the label sheet roll). A ribbon roll that winds up the used ink ribbon fed from the ribbon roll attached to the feeding shaft 10 is detachably attached to the winding shaft 12. The printing unit 20 is an example of a print unit and forms an image by transferring the ink ribbon to the label sheet.

The label sheet roll is a roll of a long strip-shaped label sheet (a printing sheet). The label sheet is an example of a printing sheet (a medium). The printing sheet is not limited to a label sheet and may be, for example, a strip-shaped thermal sheet. The label sheet roll is an example of a medium roll in which the label sheet (the printing sheet) as a medium used for printing is wound around a core material as a cylindrical body (a holder).

The label sheet wound around the label sheet roll has a plurality of labels arranged in parallel and pasted to one surface of a long backing sheet. The label has an adhesive layer on a surface on a backing sheet side and is detachable from the backing sheet. The label can be attached to another article after being peeled off from the backing sheet. The label sheet roll is obtained by rolling the label sheet around the core material in an orientation in which a surface of the backing sheet to which the labels are pasted faces inward.

The ribbon roll is a roll of a long ink ribbon. The ink ribbon is a medium that holds an ink (e.g., an image formation material) to be transferred to the label sheet by heat. The ribbon roll before use is obtained by winding an ink ribbon before ink transfer around the paper tube 30 (see FIGS. 5 and 6). A diameter of the ribbon roll before use decreases as the ink ribbon is fed out. In the configuration illustrated in FIG. 1, the ribbon roll before use is attached to the feeding shaft 10. The ribbon roll before use is an example of the medium roll in which the ink ribbon as a medium used for printing is wound around the paper tube as the cylindrical body (e.g., the holder).

A ribbon roll after use is obtained by winding the ink ribbon after the ink transfer (the ink ribbon fed out from the ribbon roll before use). In other words, an ink ribbon that is pulled out from the ribbon roll before use and wound around downstream of the printing unit 20 is the ribbon roll after use. A diameter of the ribbon roll after use gradually increases as the ink ribbon is wound around. In the configuration illustrated in FIG. 1, the ribbon roll after use is attached to the winding shaft 12.

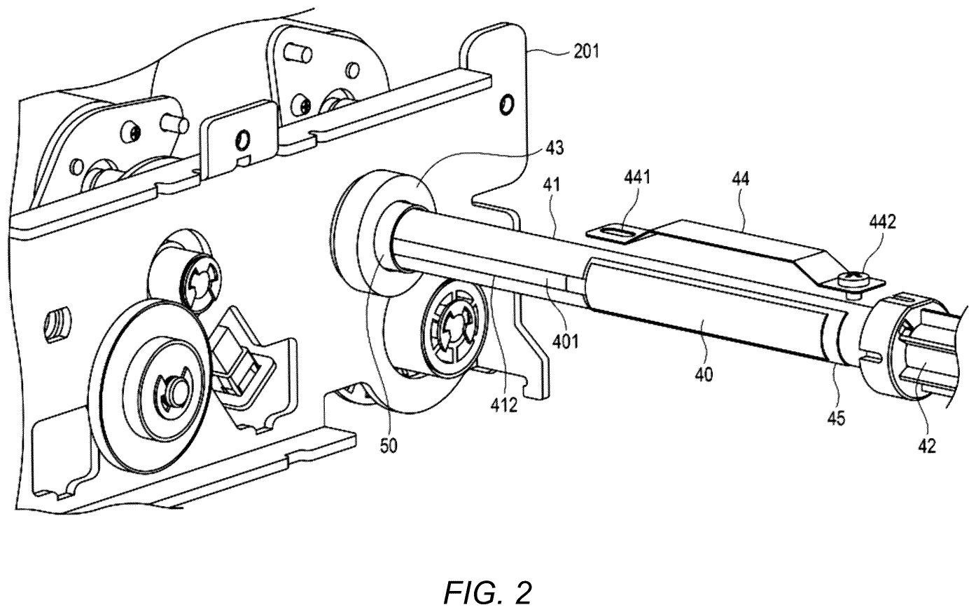

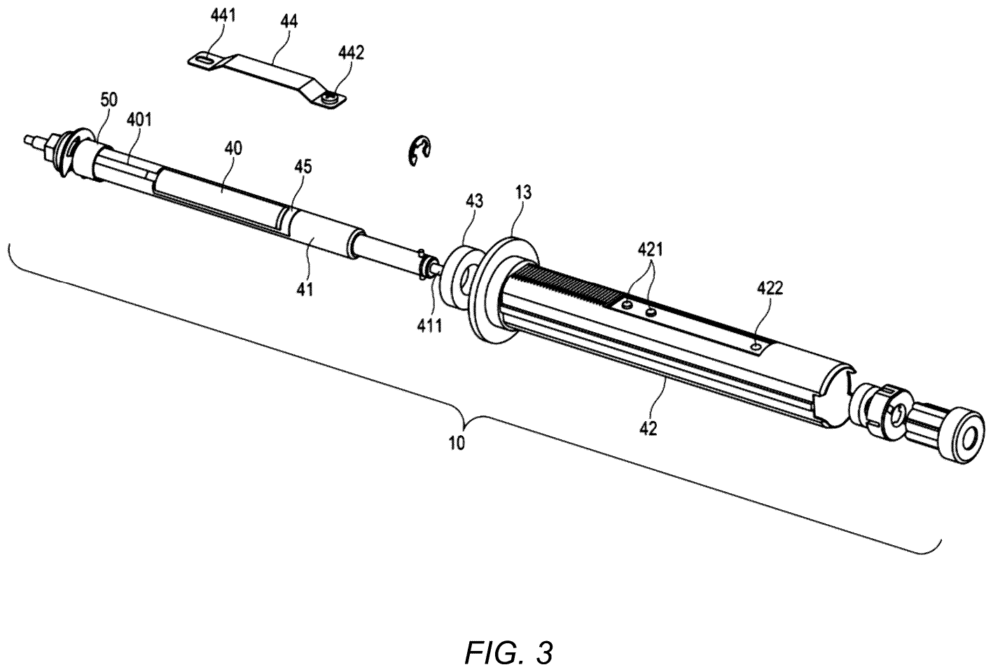

A sidewall 201 of the housing 2 fixes one end of each of the supply shaft 6, the feeding shaft 10, and the winding shaft 12. The sidewall 201 holds the three shafts 6, 10, and 12 in a cantilevered state. The winding shaft 12 has substantially the same structure as the feeding shaft 10 except that the winding shaft 12 does not include an antenna 40 to be described later (see FIGS. 2 and 3).

The supply shaft 6 includes, in the vicinity of both ends in a longitudinal direction, two hold plates 701 and 702 that abut both end surfaces of the label sheet roll in an axial direction, respectively. The hold plate 701 on an inner side close to the sidewall 201 is movable along the longitudinal direction of the supply shaft 6. The hold plate 701 determines an attachment position of the label sheet roll in the axial direction such that a center of the label sheet roll in the axial direction is aligned with a center of the label printer 100. The holding plate 702 on a proximal side, which is attached near the end portion of the supply shaft 6 on a side away from the sidewall 201 of the housing 2, is fixed to the supply shaft 6 by a fastener 703.

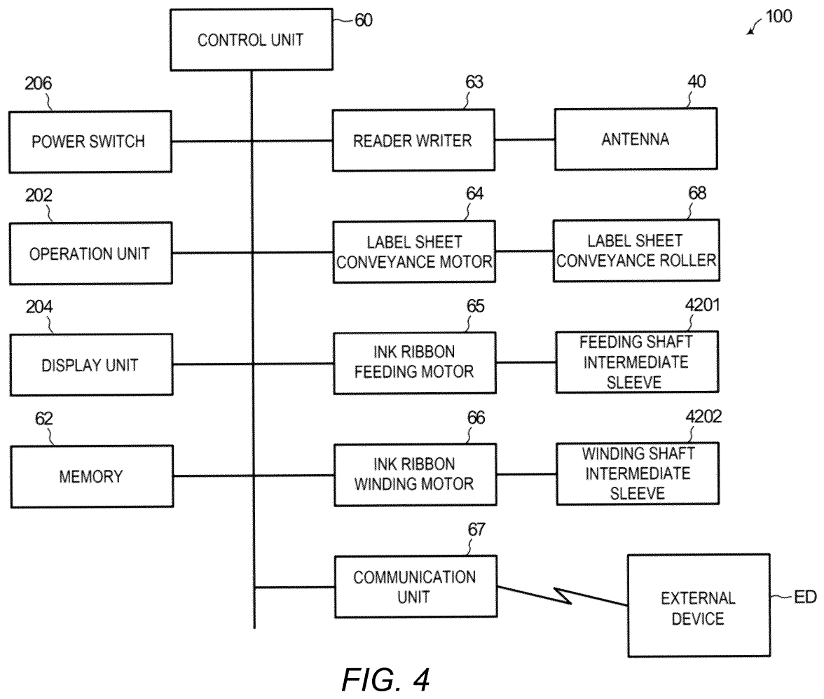

The label sheet roll is attached to the supply shaft 6 in a state in which the hold plate 702 on the proximal side is removed from the supply shaft 6. The hold plate 702 on the proximal side is attached to an end portion of the supply shaft 6 on the proximal side to which the label sheet roll is attached. The label sheet of the label sheet roll is pulled out from the label sheet roll by a label sheet conveyance roller 68 (see FIG. 4), passes through the printing unit 20, and exits the label printer 100.

The feeding shaft 10 and the winding shaft 12 of the ribbon roll include stopper plates 13 and 14 near the sidewall 201 of the housing 2, respectively. The stopper plates 13 and 14 are movable along the longitudinal direction of the shafts 10 and 12, respectively. The stopper plate 13 abuts against one end of the ribbon roll before use in the axial direction which is attached to the feeding shaft 10. The stopper plate 13 aligns the center of the ribbon roll in the axial direction with the center of the label printer 100. The stopper plate 14 abuts against one end of the ribbon roll after use in the axial direction which is attached to the winding shaft 12. The stopper plate 14 aligns the center of the ribbon roll in the axial direction with the center of the label printer 100.

A ribbon shaft fixing plate 15 is provided at a position facing end portions on the proximal side of the feeding shaft 10 and the winding shaft 12 away from the sidewall 201. The ribbon shaft fixing plate 15 is pivotably connected via a hinge 16 to a support plate 203 standing upward from a bottom wall 205 of the housing 2. The ribbon shaft fixing plate 15 has a reception hole 151 and a reception hole 152. The reception hole 151 receives a tip end 411 of a fixed shaft 41 to be described later with reference to the feeding shaft 10 (hereinafter, also simply referred to as a tip end 411 of the feeding shaft 10). The reception hole 152 receives a tip end 121 of the winding shaft 12. The ribbon shaft fixing plate 15 has an insertion hole 153 through which a head lever 21 of the printing unit 20 is inserted.

When the ribbon roll is attached to the feeding shaft 10, the ribbon shaft fixing plate 15 is opened to a position (not illustrated), and the ribbon roll is attached to the feeding shaft 10. The ribbon shaft fixing plate 15 pivots to the illustrated position. The tip end 411 of the feeding shaft 10 is inserted into the reception hole 151. The tip end 121 of the winding shaft 12 is inserted into the reception hole 152. In this state, the ribbon shaft fixing plate 15 fixes the tip end 411 of the feeding shaft 10 and the tip end 121 of the winding shaft 12.

The ink ribbon pulled out from the ribbon roll attached to the feeding shaft 10 passes through the printing unit 20 and is wound around the winding shaft 12. The printing unit 20 conveys the ink ribbon superimposed on the label sheet and causes the ink ribbon to pass through the printing unit 20 at the same speed as that of the label sheet.

The printing unit 20 includes a thermal head disposed on a side of the ink ribbon opposite to the label sheet. The printing unit 20 includes a platen roller at a position facing the thermal head with the ink ribbon and the label sheet interposed therebetween. The printing unit 20 thermally transfers the ink of the ink ribbon to the label sheet by pressing the ink ribbon against the label sheet by the thermal head. For example, the printing unit 20 prints an image for a label such as a two-dimensional bar code, on each label of the label sheet.

FIG. 2 is a partially enlarged perspective view illustrating main parts of the feeding shaft 10 in the label printer 100 as the printing device according to the embodiment. FIG. 3 is an exploded perspective view of the feeding shaft 10 in the label printer 100 as the printing device according to the embodiment. The winding shaft 12 has substantially the same structure as that of the feeding shaft 10 illustrated in FIGS. 2 and 3 except that the winding shaft 12 does not include the antenna 40.

As illustrated in FIGS. 2 and 3, the feeding shaft 10 includes the fixed shaft 41, an intermediate sleeve 42, and a bearing 43. The fixed shaft 41 is fixed to the sidewall 201 of the housing 2 in a cantilevered state. The intermediate sleeve 42 is coaxially disposed outside the fixed shaft 41. The bearing 43 is coaxially disposed outside the fixed shaft 41.

The fixed shaft 41 is, for example, a solid metal shaft and is fixed to the sidewall 201 of the housing 2 in a cantilevered state using a bolt. The tip end 411 of the fixed shaft 41 protrudes from a proximal end portion of the intermediate sleeve 42.

The intermediate sleeve 42 has a substantially cylindrical shape and includes the bearing 43 therein near an end portion on a sidewall 201 side. The bearing 43 is fixed to the intermediate sleeve 42 by being fitted into an inner side of the end portion of the intermediate sleeve 42. The bearing 43 has a cylindrical shape and can be formed of resin or metal. An inner diameter of the intermediate sleeve 42 is substantially the same as an outer diameter of the bearing 43.

The intermediate sleeve 42 is rotatable (e.g., pivotable) with respect to the fixed shaft 41 by the bearing 43. The intermediate sleeve 42 includes the above-described stopper plate 13 on an outer side near the end portion on the sidewall 201. The stopper plate 13 is movable in the longitudinal direction of the intermediate sleeve 42 and can be fixed at a desired position in the longitudinal direction.

Two boss portions 421 for positioning a plate spring 44 and a screw hole 422 for fastening and fixing the plate spring 44 to an outer peripheral surface of the intermediate sleeve 42 are provided in the outer peripheral surface of the intermediate sleeve 42. The plate spring 44 has a slit 441 through which the boss portions 421 are inserted at one end on the sidewall 201 side and has a screw hole through which a screw 442 is inserted at the other end. The plate spring 44 is fixed to the outer peripheral surface of the intermediate sleeve 42 by inserting the boss portions 421 of the intermediate sleeve 42 into the slit 441 and screwing the screw 442 into the screw hole 422.

For example, the plate spring 44 is formed of metal. The plate spring 44 presses an inner surface of the paper tube 30 outward in a state in which the paper tube 30 of the ribbon roll is attached to an outer side of the intermediate sleeve 42, and fixes the paper tube 30 to the intermediate sleeve 42. The plate spring 44 protrudes from the outer peripheral surface of the intermediate sleeve 42 to such an extent that the intermediate sleeve 42 can be inserted into the paper tube 30. The plate spring 44 has a width in a circumferential direction less than a width of the antenna 40 along the circumferential direction of the fixed shaft 41.

The sheet-shaped antenna 40 is provided in the outer peripheral surface of the fixed shaft 41. On the outer peripheral surface of the fixed shaft 41, there is a wiring 401 electrically connected to the antenna 40 and extending in the longitudinal direction of the fixed shaft 41. The antenna 40 and the wiring 401 are, for example, a continuous metal foil and may be formed by patterning a metal foil on a surface of a flexible substrate. For example, a pattern of the antenna 40 is in a shape of a loop antenna to generate a magnetic field.

A magnetic sheet 45 is provided between the outer peripheral surface of the fixed shaft 41 and the antenna 40. The magnetic sheet 45 is provided such that an Eddy current is generated in the fixed shaft 41 formed of metal by the magnetic field generated by the antenna 40 and the magnetic field generated by the antenna 40 is not canceled. Therefore, the magnetic sheet 45 has a size slightly larger than that of the antenna 40 to be present between the antenna 40 and the fixed shaft 41.

The antenna 40 is separated from the outer peripheral surface of the fixed shaft 41 by a thickness of the magnetic sheet 45. Therefore, an end portion of the wiring 401 on an antenna 40 side is slightly inclined toward the antenna 40 in a direction away from the outer peripheral surface of the fixed shaft 41. Since the bearing 43 is provided between the intermediate sleeve 42 and the fixed shaft 41, the inner diameter of the intermediate sleeve 42 is sufficiently larger than an outer diameter of the fixed shaft 41. Therefore, the antenna 40 and the wiring 401 do not come into sliding contact with an inner surface of the intermediate sleeve 42. For example, even when the fixed shaft 41 is inserted into the intermediate sleeve 42 or the intermediate sleeve 42 rotates with respect to the fixed shaft 41, the antenna 40 and the wiring 401 do not come into sliding contact with the inner surface of the intermediate sleeve 42.

FIG. 4 is a block diagram illustrating a configuration example of a control system of the label printer 100 as the printing device according to the embodiment.

As illustrated in FIG. 4, the label printer 100 includes a control unit 60 (e.g., controller) that performs various controls. For example, the control unit 60 is implemented by a processor such as a central processing unit (CPU). In addition, the processor may be a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor may be a combination of a plurality of these described above.

The control unit 60 is connected to the power switch 206, the operation unit 202 (e.g., operator), the display unit 204 (e.g., display device), a memory 62, a reader writer 63, a label sheet conveyance motor 64, an ink ribbon feeding motor 65, an ink ribbon winding motor 66, and a communication unit 67 (e.g., communicator).

The memory 62 includes, for example, a rewritable nonvolatile memory. The memory 62 stores various types of data such as a control program and control data. For example, the memory 62 stores data related to a printing speed corresponding to the ink ribbon.

The reader writer 63 is an example of a reader. The reader writer 63 is a device that wirelessly communicates with a wireless tag 32 via the antenna 40. For example, the reader writer 63 reads data recorded in the wireless tag 32 by the wireless communication with the wireless tag 32 via the antenna 40.

The label sheet conveyance motor 64 rotates the label sheet conveyance roller 68 that pulls out the label sheet from the label sheet roll.

The ink ribbon feeding motor (hereinafter, also simply referred to as a feeding motor) 65 rotates the intermediate sleeve 42 (4201) of the feeding shaft 10. The ribbon roll before use is set on the intermediate sleeve 4201 of the feeding shaft 10.

The feeding motor 65 is implemented by, for example, a motor such as a DC motor and is driven (e.g., rotated) under the control of the control unit 60. A rotation direction and a rotation torque of the feeding motor 65 are controlled by the control unit 60. For example, the feeding motor 65 rotates in a predetermined first direction (a positive direction) when a positive voltage is applied and rotates in a direction opposite to the first direction (a reverse direction) when a negative voltage is applied. Further, a torque for rotating the intermediate sleeve of the feeding shaft 10 is controlled by a magnitude of the voltage applied to the feeding motor 65.

The ink ribbon winding motor (e.g., a winding motor) 66 rotates the intermediate sleeve 42 (4202) of the winding shaft 12. The ribbon roll after use around which the ink ribbon fed from the ribbon roll before use is wound is set on the intermediate sleeve 4202 of the winding shaft 12. Similarly to the feeding motor 65, the winding motor 66 is implemented by a motor such as a DC motor and is driven (rotated) under the control of the control unit 60. The control unit 60 drives the winding motor 66 to rotate the intermediate sleeve 4202 of the winding shaft 12, thereby winding the ink ribbon fed from the ribbon roll before use. The paper tube 30 of the ribbon roll attached to the intermediate sleeve 4201 of the feeding shaft 10 rotates according to the winding of the ink ribbon by the intermediate sleeve 4202 of the winding shaft 12.

The control unit 60 may rotate only the feeding motor 65 in the positive direction without driving the winding motor 66. When the feeding motor 65 rotates in the positive direction, the paper tube 30 of the ribbon roll before use set on the intermediate sleeve 4201 of the feeding shaft 10 rotates, and the ink ribbon is fed out. When the ink ribbon is fed out, the control unit 60 may rotate the feeding motor 65 in the reverse direction by an amount corresponding to an amount of rotation of the feeding motor 65 in the positive direction. When the feeding motor 65 rotates in the reverse direction, the ink ribbon in an amount of feeding is rewound onto the ribbon roll before being attached to the intermediate sleeve 4201 of the feeding shaft 10. When the ink ribbon is fed out, the control unit 60 may rewind the ink ribbon fed out by rotating the feeding motor 65 in the reverse direction at a low voltage for a predetermined time.

The communication unit 67 is implemented by a communication interface for communicating with an external device ED such as a host computer. The communication unit 67 may be an interface for wired communication or an interface for wireless communication. The communication unit 67 transmits and receives various types of data to and from the external device ED.

Next, a ribbon roll to be attached to the feeding shaft 10 in the label printer 100 as the printing device according to the embodiment will be described.

FIGS. 5 and 6 are perspective views illustrating examples of the paper tube 30 of the ribbon roll to be attached to the feeding shaft 10.

The ribbon roll to be attached to the feeding shaft 10 is obtained by winding the ink ribbon around an outer peripheral surface of the paper tube 30. A diameter and a length of the paper tube 30 of the ribbon roll are defined by a shape and a size of the feeding shaft 10 of the label printer 100.

As illustrated in FIGS. 5 and 6, the wireless tag 32 is provided outside the paper tube 30 of the ribbon roll. The wireless tag 32 includes a loop antenna and an IC circuit including a processor and a memory (an internal memory) and is driven by power generated by receiving the magnetic field generated in the antenna 40. The wireless tag 32 only needs to be provided on the paper tube 30, and may be provided on an inner surface of the paper tube 30 or on an intermediate portion between the outer peripheral surface and the inner surface of the paper tube 30. The wireless tag 32 attached to an outer peripheral surface 301 of the paper tube 30 is not limited to a specific shape and size and only needs to be provided on the paper tube 30.

The paper tube 30 of the ribbon roll is attached to the feeding shaft 10 in any orientation. That is, a position of the wireless tag 32 in the circumferential direction with respect to the antenna 40 when the ribbon roll is attached to the feeding shaft 10 is not defined. Therefore, the wireless tag 32 may be attached facing directly toward the antenna 40 or in an opposite orientation.

The ribbon roll attached to the feeding shaft 10 is replaced in a state in which the power switch 206 is turned off and the cover 4 of the housing 2 is opened in the label printer 100. After the ribbon roll of the feeding shaft 10 is replaced, the power switch 206 is turned on. When the power switch 206 is turned on, the control unit 60 reads the data from the wireless tag 32 by the reader writer 63. The wireless tag 32 stores the data related to the ink ribbon (e.g., the image formation material) wound around the paper tube 30. For example, the data related to the ink ribbon includes a product name, a type (e.g., for plain sheet or for thick sheet), a width, a length, a manufacturing date, a serial number (e.g., a manufacturing number), and a remaining amount of the ink ribbon.

The control unit 60 controls printing using the ink ribbon based on information read from the wireless tag 32. For example, based on the information read from the wireless tag 32, the control unit 60 performs printing control settings such as the printing speed corresponding to the ink ribbon. Accordingly, the control unit 60 controls the label sheet conveyance motor 64, the ink ribbon feeding motor 65, and the ink ribbon winding motor 66 to perform the printing control corresponding to the ink ribbon.

Next, the wireless tag 32 in the ribbon roll to be attached to the feeding shaft 10 of the label printer 100 as the printing device according to the embodiment will be described.

FIGS. 5 and 6 are perspective views illustrating examples of the paper tube 30 of the ribbon roll to be attached to the feeding shaft 10.

FIG. 5 illustrates a wireless tag TagA as a first example of the wireless tag 32 attached to the paper tube 30 of the ribbon roll to be attached to the feeding shaft 10. FIG. 6 illustrates a wireless tag TagB as a second example of the wireless tag 32 attached to the paper tube 30 of the ribbon roll to be attached to the feeding shaft 10.

The wireless tag 32 illustrated in FIGS. 5 and 6 is attached by adhesion to the outer peripheral surface 301 of the paper tube 30 at substantially a center of the paper tube 30 in the axial direction. The wireless tag TagA illustrated in FIG. 5 is an example of a sheet-shaped wireless tag including a circular loop antenna having a predetermined diameter (e.g., @35 mm). The wireless tag TagB illustrated in FIG. 6 is an example of a rectangular sheet-shaped wireless tag including a loop antenna having a predetermined rectangular size (e.g., 31 mm×14 mm).

As described above, in the ribbon roll used in the label printer 100, the shape and the size of the wireless tag 32 provided on the paper tube 30 are not specified. In the ribbon roll, the paper tube 30 is attached to the feeding shaft 10 at any orientation. That is, the wireless tag 32 provided on the paper tube 30 of the ribbon roll attached to the feeding shaft 10 has a free shape and a free size and has a free positional relationship with respect to the antenna 40. The control unit 60 performs control such that the reader writer 63 can read the data from the wireless tag 32 even when the wireless tag 32 having a free shape and a free size is attached to any position.

Next, data reading processing from the wireless tag 32 according to the positional relationship between the wireless tag 32 and the antenna 40 will be described.

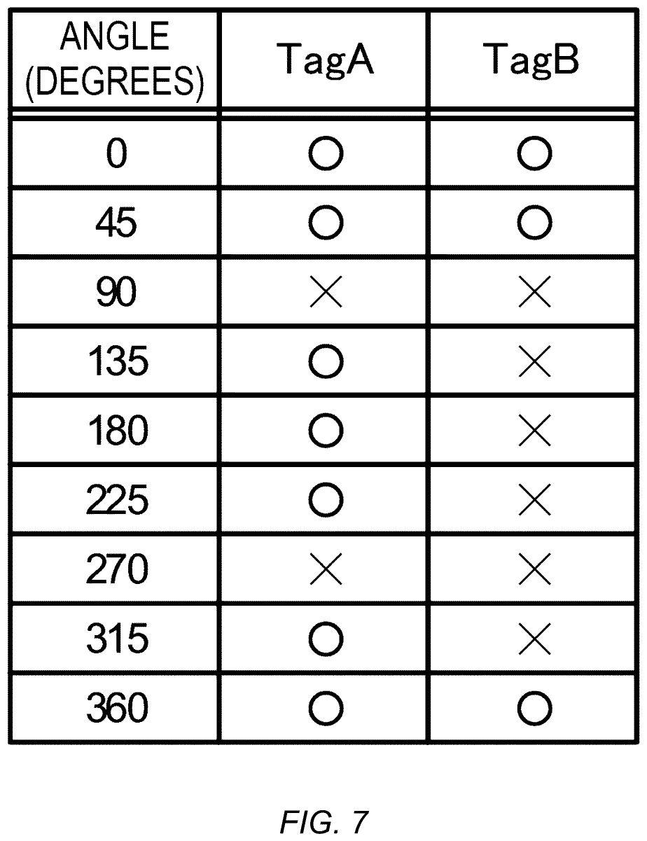

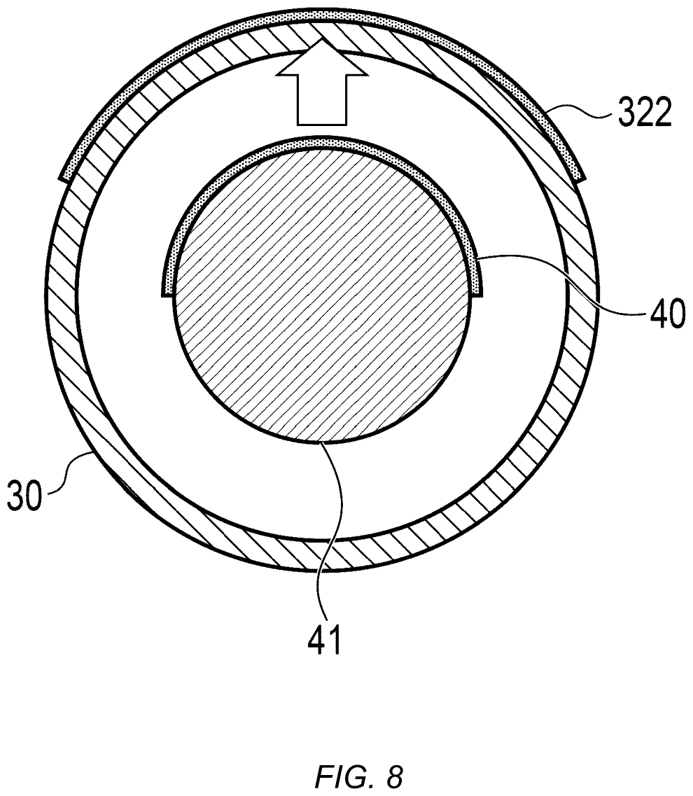

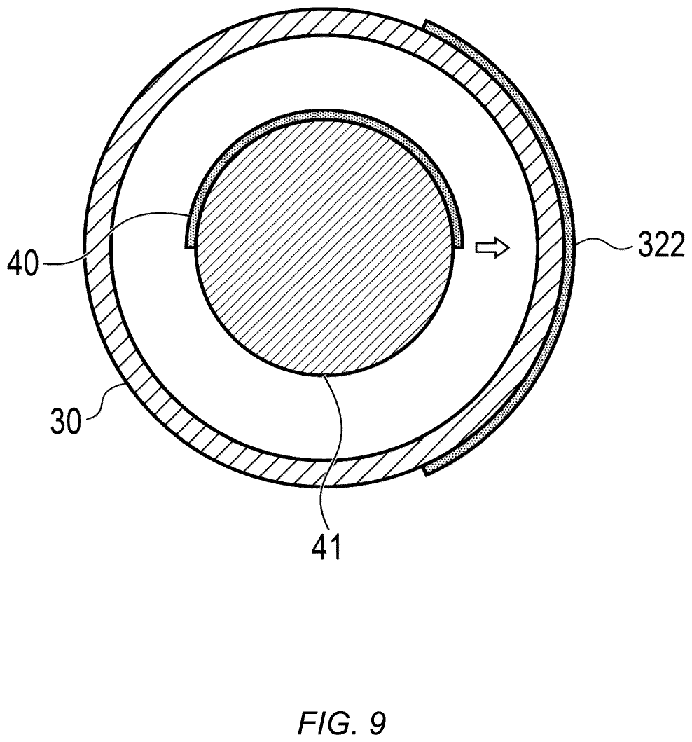

FIG. 7 is a diagram illustrating examples of a data reading result from the wireless tag according to the positional relationship (e.g., an angle) between the antenna 40 and the wireless tag 32 (e.g., the wireless tag TagA and the wireless tag TagB) provided on the paper tube 30. FIG. 8 is a schematic diagram illustrating a state in which the angle between the antenna 40 and the wireless tag 32 provided on the paper tube 30 is 0 degrees. FIG. 9 is a schematic diagram illustrating a state in which the angle between the wireless tag 32 and the antenna 40 is 90 degrees.

Here, the angle between the wireless tag 32 and the antenna 40 indicates a positional relationship of a center point (referred to as a center of the wireless tag 32) of a width of the wireless tag 32 in a radial direction with respect to a center point (referred to as a center of the antenna 40) of a width of the antenna 40 in the radial direction. Specifically, the angle between the wireless tag 32 and the antenna 40 indicates a clockwise angle from the center of the diameter of the antenna 40 with a normal direction passing through the center of the antenna 40 as 0 degrees.

In the example illustrated in FIG. 8, since the center of the wireless tag 32 is in the normal direction passing through the center of the antenna 40, the angle between the wireless tag 32 and the antenna 40 is 0 degrees. In the example illustrated in FIG. 9, since the center of the wireless tag 32 is at a position of 90 degrees from the normal direction passing through the center of the antenna 40, the angle between the wireless tag 32 and the antenna 40 is 90 degrees.

In FIGS. 8 and 9, outlined arrows indicate a main direction and a magnitude of the magnetic field generated in the antenna 40. In the examples illustrated in FIGS. 8 and 9, the width of the antenna 40 in the radial direction of the fixed shaft 41 is half the width of the fixed shaft 41 in the radial direction (e.g., the antenna 40 covers the half of the fixed shaft 41 in the radial direction). As illustrated in FIGS. 8 and 9, the magnetic field generated by the antenna 40 is strong at a central portion of the antenna 40 in the radial direction and is weak at an end portion.

As illustrated in FIG. 8, when the angle between the wireless tag 32 and the antenna 40 is 0 degrees, the wireless tag 32 receives a strong magnetic field generated by the antenna 40. When receiving the strong magnetic field, the wireless tag 32 can acquire (generate) power for operations necessary for performing data communication from the antenna 40. In a state in which the wireless tag 32 generates the power necessary for the operations, stable data communication between the reader writer 63 and the wireless tag 32 can be performed. As a result, when the angle between the wireless tag 32 and the antenna 40 is 0 degrees, the control unit 60 succeeds in reading the data from the wireless tag 32 by the reader writer 63.

In contrast, as illustrated in FIG. 9, when the angle between the wireless tag 32 and the antenna 40 is 90 degrees, the wireless tag 32 is less likely to receive the magnetic field generated in the antenna 40. When the received magnetic field is weak, the wireless tag 32 cannot acquire (e.g., generate) power for operations necessary for performing data communication from the antenna 40. When the wireless tag 32 cannot generate the power necessary for the operations, stable data communication between the reader writer 63 and the wireless tag 32 is less likely to be performed. As a result, when the angle between the wireless tag 32 and the antenna 40 is 90 degrees, the control unit 60 fails to read the data from the wireless tag 32 by the reader writer 63.

In the data reading result illustrated in FIG. 7, a round mark indicates that the data reading is successful, and a cross mark indicates that the data reading is unsuccessful. In the example illustrated in FIG. 7, the reader writer 63 is unable to read the data from the wireless tags TagA and TagB when angles with the antenna 40 are 90 degrees or 270 degrees. The reader writer 63 also is unable to read the data from the wireless tag TagB when the angle with the antenna 40 is 90 degrees to 315 degrees.

The wireless tag 32 provided on the paper tube 30 generates power for operations according to the magnetic field generated in the antenna 40 by electromagnetic induction. When the magnetic field passing through the loop antenna of the wireless tag 32 is weak, the wireless tag 32 cannot generate the power necessary for the operations and cannot perform normal data reading (e.g., data communication). The reading results illustrated in FIG. 7 indicate that the smaller the wireless tag 32 provided on the paper tube 30 is, the wider the range of the angle at which the data reading fails is. The reading results illustrated in FIG. 7 indicate that the data reading is successful even when the wireless tag 32 is small when the angle between the wireless tag 32 and the antenna 40 is around 0 degrees.

In the label printer 100, the angle between the antenna 40 and the wireless tag 32 provided on the ribbon roll changes as the ribbon roll rotates. In the label printer 100, the ribbon roll is attached to the feeding shaft 10 in any orientation (in a state in which an angle between the wireless tag and the antenna is free). Therefore, the label printer 100 reads the data from the wireless tag 32 by rotating the ribbon roll (changing the angle between the wireless tag 32 and the antenna 40).

Since the angle between the wireless tag 32 and the antenna 40 changes as the ribbon roll rotates (e.g., as the ribbon roll moves to the wireless tag 32), an amplitude of a response signal of the wireless tag 32 received by the reader writer 63 via the antenna 40 fluctuates. As a result, the data of the wireless tag 32 is less likely to be read accurately. Therefore, the control unit 60 of the label printer 100 reads the data from the wireless tag 32 in a state in which the rotation of the ribbon roll is stopped. When the data cannot be read from the wireless tag 32, the control unit 60 of the label printer 100 repeatedly performs data reading in a state in which the ribbon roll is further rotated and then stopped.

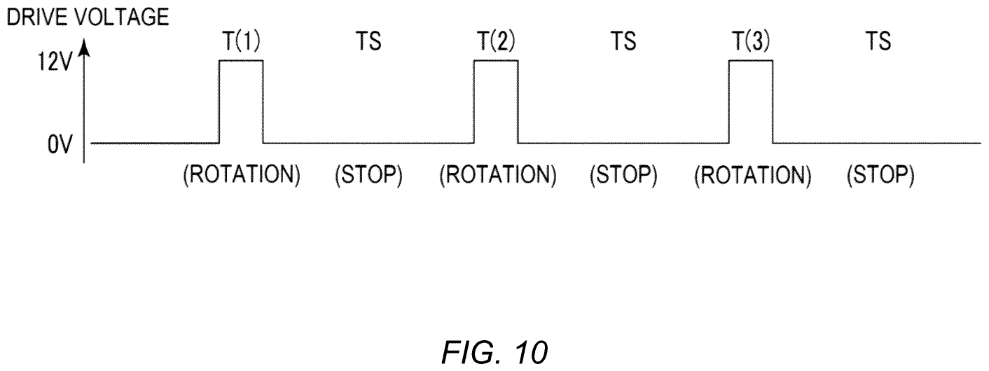

FIG. 10 is a diagram illustrating an example of an operation timing when the label printer 100 as the printing device according to the embodiment executes the data reading processing of the wireless tag 32.

The control unit 60 repeatedly executes rotation (e.g., pivoting) and stop of the paper tube 30 attached to the feeding shaft 10 and the data reading processing of the wireless tag 32 until a predetermined maximum value is reached. In the example illustrated in FIG. 10, T(n) is a rotation time (e.g., a pivot time) during which the paper tube 30 attached to the feeding shaft 10 is rotated with a counter n as a variable (n=1, 2, . . . and 5). For example, T(n) (T(1), T(2), . . . and T(5)) is set to be any time. In the example illustrated in FIG. 10, TS is a predetermined processing time for executing the data reading processing of the wireless tag 32.

According to the example illustrated in FIG. 10, the control unit 60 executes the data reading processing for a TS time in a state in which the paper tube 30 including the wireless tag 32 is rotated for a T(1) time and then stopped. When the data cannot be read in a state in which the paper tube 30 is rotated for the T(1) time, the control unit 60 further executes the data reading processing for the time TS in a state in which the paper tube 30 is rotated for the T(2) time and then stopped. That is, the control unit 60 repeatedly executes the data reading processing for the TS time in a state in which the paper tube 30 is rotated for the T(n) time and then stopped until the data can be read from the wireless tag 32 (or until the number of times the paper tube 30 is rotated exceeds a predetermined maximum value).

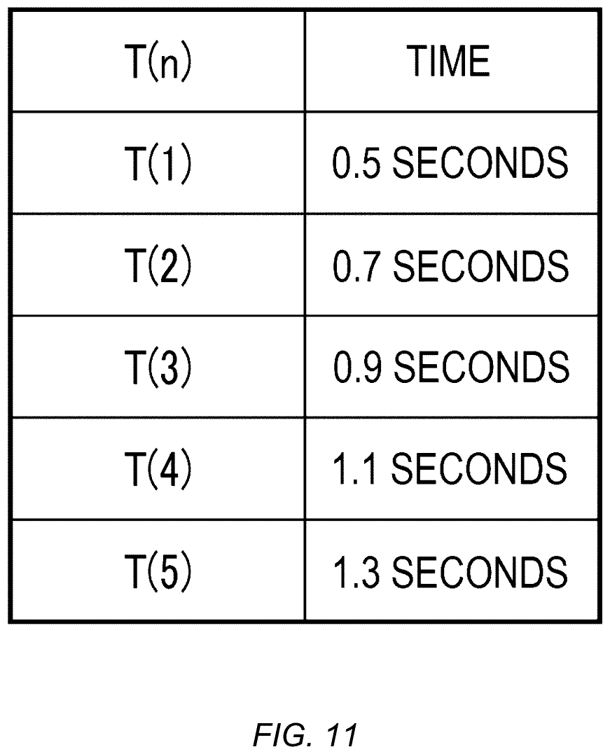

FIG. 11 is a diagram illustrating setting examples of T(n) which is a rotation time for rotating the paper tube 30 attached to the feeding shaft 10.

T(n) is set to be any time such that the angle between the wireless tag 32 and the antenna 40 does not repeatedly become the same angle. In the example illustrated in FIGS. 11, n=1, 2, . . . and 5, T(1) is 0.5 seconds, T(2) is 0.7 seconds, T(3) is 0.9 seconds, T(4) is 1.1 seconds, and T(5) is 1.3 seconds.

For example, T(n) is set to be any time (e.g., rotation time). By repeating the rotation for any time, the paper tube 30 including the wireless tag 32 fluctuates at any rotation angle (e.g., at a fluctuation amount of the angle between the wireless tag 32 and the antenna 40). In contrast, T(n) may be set to a constant time such that the angle between the wireless tag 32 and the antenna 40 does not become an angle at which the data reading repeatedly fails.

That is, the rotation time set as T(n) is set such that the angle between the wireless tag 32 and the antenna 40 does not become an angle (e.g., 90 degrees or 270 degrees) at which the data reading repeatedly fails. A maximum value (Nmax) of “n”, which is the number of repetitions of the rotation of the paper tube 30 (e.g., the number of repetitions of the data reading processing), is set in advance.

For example, the rotation time T(n) as illustrated in FIG. 11 may be stored in the memory 62 as a preset value. The rotation time T(n) may be randomly selected by the control unit 60 under a predetermined condition.

According to the operations at the timings illustrated in FIG. 10, the angle between the wireless tag 32 and the antenna 40 fluctuates at any angle as the paper tube 30 rotates for any rotation time (e.g., a first rotation time). Therefore, the reader writer 63 can be expected to read the data from the wireless tag 32 at any timing. Further, since the control unit 60 controls the rotation of the paper tube 30 by the rotation time, the rotation angle of the paper tube 30 may not be precisely controlled (e.g., the rotation angle may not be strictly grasped). Accordingly, the control unit 60 can easily perform the control even in a mechanism that rotates the feeding shaft 10 and the winding shaft 12 by a DC motor, which is less likely to strictly grasp the rotation angle.

Next, a first operation example of the data reading processing on the wireless tag 32 provided on the paper tube 30 in the label printer 100 as the printing device according to the embodiment will be described.

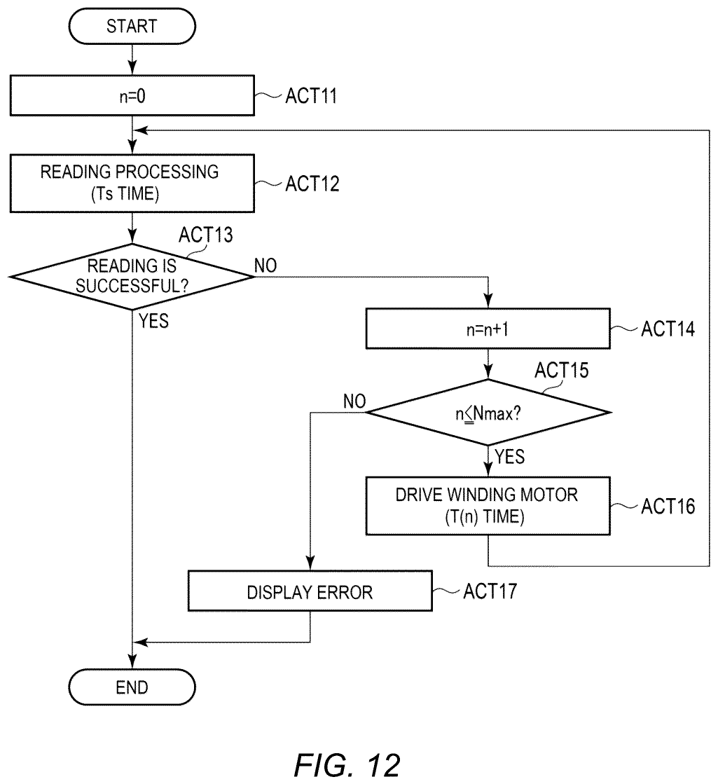

FIG. 12 is a flowchart illustrating the first operation example of the data reading processing on the wireless tag 32 provided on the paper tube 30 in the label printer 100.

Here, when the power switch 206 is turned on, the control unit 60 of the label printer 100 starts the operation of the data reading processing illustrated in FIG. 12 on the wireless tag 32.

However, a timing of starting the data reading processing on the wireless tag 32 is not limited to the case in which the power switch 206 is turned on. The control unit 60 can stop the rotation of the paper tube 30 and execute the data reading processing on the wireless tag at any timing as long as the sheet feeding is stopped. For example, the control unit 60 may start the data reading processing on the wireless tag 32 according to the operation of the operation unit 202. The control unit 60 may start the data reading processing on the wireless tag 32 according to an instruction from the external device ED communicating via the communication unit 67.

When the data reading processing on the wireless tag 32 is started, the control unit 60 sets a value of the counter n provided in the internal memory or the memory 62 to “0” as an initial value (ACT 11). When the initial value is set to the counter n, the control unit 60 executes the data reading processing on the wireless tag 32 for a predetermined processing time (TS time) in a state in which the feeding shaft 10 is stopped (ACT 12). For example, the control unit 60 instructs the reader writer 63 to read the data stored in the wireless tag 32 and acquires the data reading result from the reader writer 63.

The reader writer 63 generates the magnetic field in the antenna 40 under the control of the control unit 60 and transmits a data read request to the wireless tag 32 via the antenna 40. Meanwhile, the wireless tag 32 provided on the paper tube 30 attached to the feeding shaft 10 is driven by the power generated by the magnetic field from the antenna 40. When the wireless tag 32 is activated by the generated power, the wireless tag 32 outputs the data (the data related to the ink ribbon) stored in the internal memory in response to the read request from the reader writer 63.

The reader writer 63 receives the data output by the wireless tag 32 as a response to the data read request. When receiving the data from the wireless tag 32, the reader writer 63 supplies the received data to the control unit 60. When the reader writer 63 can acquire the data output from the wireless tag 32 via the antenna 40, the control unit 60 determines that the reading is successful, and when the reader writer 63 cannot acquire the data, the control unit 60 determines that the reading fails.

If the reading of the data from the wireless tag 32 is successful (YES in ACT 13), the control unit 60 ends the data reading processing on the wireless tag 32. When the reading of the data from the wireless tag 32 is successful, the control unit 60 performs, for example, printing settings based on the data read from the wireless tag 32.

When the reading of the data from the wireless tag 32 fails (NO in ACT 13), the control unit 60 increments the value of the counter n (n=n+1) (ACT 14). When the counter n is incremented, the control unit 60 determines whether the counter n is equal to or less than the maximum value Nmax (ACT 15). The maximum value Nmax is the maximum value of the variable n set as T(n). In the setting example illustrated in FIG. 11, since the variable n of T(n) is n=1, 2, . . . and 5, Nmax is “5”. In this case (when Nmax=5), the control unit 60 determines whether the counter n is “5” or less.

If the counter n is equal to or less than Nmax (YES in ACT 15), the control unit 60 drives the winding motor 66 by the T(n) time (ACT 16). When the winding motor 66 is driven for the T(n) time, the intermediate sleeve 4202 of the winding shaft 12 rotates for the T(n) time. The intermediate sleeve 4202 of the winding shaft 12 rotates to wind the ink ribbon fed from the ribbon roll of the paper tube 30 attached to the feeding shaft 10. Accordingly, the paper tube 30 of the ribbon roll attached to the feeding shaft 10 rotates by an amount of the ink ribbon wound around the winding shaft 12 (e.g., an amount of feeding the ink ribbon).

That is, the paper tube 30 provided with the wireless tag 32 and attached to the feeding shaft 10 rotates by the T(n) time by the driving of the winding motor 66. When the paper tube 30 rotates for the T(n) time, the positional relationship (the angle) between the wireless tag 32 and the antenna 40 changes according to a rotation amount of the paper tube 30 for the T(n) time. The control unit 60 changes the angle between the wireless tag 32 and the antenna 40 by driving the winding motor 66 for the T(n) time, and then returns to ACT 12 to execute the data reading processing again. Accordingly, the control unit 60 can perform the data reading processing in a state in which the positional relationship between the wireless tag 32 and the antenna 40 fluctuates.

If the counter n exceeds Nmax (NO in ACT 15), the control unit 60 notifies an error (ACT 17). For example, the control unit 60 notifies the error by displaying, on the display unit 204, an error message indicating that the data cannot be read from the wireless tag 32. When the error message is displayed on the display unit 204, the control unit 60 ends the data reading processing on the wireless tag 32.

As described above, in the first operation example, when data reading from the wireless tag 32 fails, the control unit 60 of the label printer 100 rotates the paper tube 30 including the wireless tag 32 for any rotation time. The control unit 60 causes the reader writer 63 to execute the data reading processing on the wireless tag 32 in a state in which the paper tube 30 rotated for any rotation time is stopped. The control unit 60 repeatedly performs processing of causing the reader writer 63 to execute the data reading processing in a state in which the paper tube 30 is rotated for any rotation time (e.g., a rotation time different than or same as the first rotation time) and then stopped until the data reading from the wireless tag 32 is successful.

Accordingly, when the data cannot be read from the wireless tag 32, the label printer 100 can change the positional relationship between the wireless tag 32 and the antenna 40 to retry the data reading processing. As a result, the label printer 100 as the printing device can read the data from the wireless tag 32 with simple control even when the wireless tag 32 having any shape and any size is attached to any position.

When the data cannot be read from the wireless tag 32, the control unit 60 of the label printer 100 repeatedly executes the rotation of the paper tube 30 and the data reading processing until the number of times of repeated execution exceeds a predetermined maximum value. When the number of times the paper tube 30 is rotated exceeds the predetermined maximum value, the control unit 60 stops the rotation of the paper tube 30, notifies an error, and then ends the data reading processing on the wireless tag 32. Accordingly, the label printer 100 as the printing device can prevent a large amount of unused ink ribbon from being fed out and can reduce consumption of the ink ribbon and waste of power.

The control unit 60 of the label printer 100 executes the data reading processing on the wireless tag 32 by the reader writer 63 in a state in which the rotation of the paper tube 30 is stopped. Accordingly, the reader writer 63 can prevent a data reading failure caused by the movement of the wireless tag 32 and can reliably read the data from the wireless tag 32.

Next, a second operation example of the data reading processing on the wireless tag 32 provided on the paper tube 30 in the label printer 100 as the printing device according to the embodiment will be described.

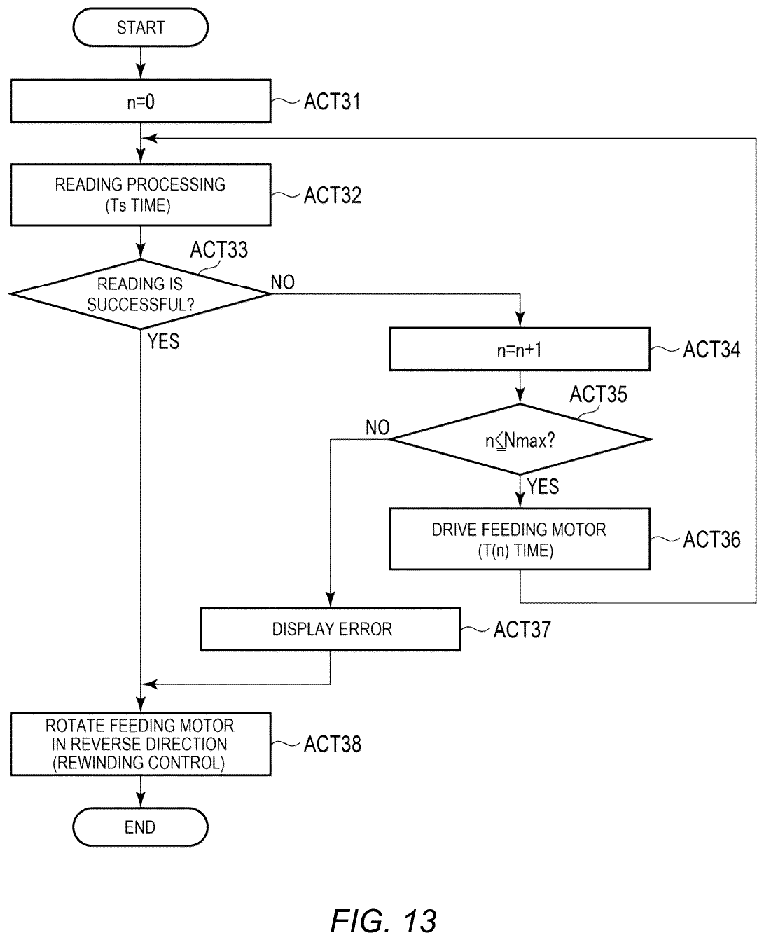

FIG. 13 is a flowchart illustrating the second operation example of the data reading processing on the wireless tag 32 provided on the paper tube 30 in the label printer 100.

Here, when the power switch 206 is turned on, the control unit 60 of the label printer 100 starts the operation of the data reading processing illustrated in FIG. 13 on the wireless tag 32. However, even in the second operation example, a timing of starting the data reading processing on the wireless tag 32 is not limited to the case in which the power switch 206 is turned on.

When the data reading processing is started, the control unit 60 sets a value of the counter n provided in the internal memory or the memory 62 to “0” as an initial value (ACT 31). When the initial value is set to the counter n, the control unit 60 executes the data reading processing on the wireless tag 32 for a predetermined processing time (the TS time) in a state in which the feeding shaft 10 is stopped (ACT 32). For example, the control unit 60 instructs the reader writer 63 to read the data stored in the wireless tag 32 and acquires the data reading result from the reader writer 63.

The reader writer 63 generates the magnetic field in the antenna 40 under the control of the control unit 60 and transmits a data read request to the wireless tag 32 via the antenna 40. Meanwhile, the wireless tag 32 provided on the paper tube 30 attached to the feeding shaft 10 is driven by the power generated by the magnetic field from the antenna 40. When the wireless tag 32 is activated by the generated power, the wireless tag 32 outputs the data stored in the internal memory in response to the read request from the reader writer 63.

The reader writer 63 receives the data output by the wireless tag 32 as a response to the data read request. When receiving the data from the wireless tag 32, the reader writer 63 supplies the received data to the control unit 60. When the reader writer 63 can acquire the data output from the wireless tag 32 via the antenna 40, the control unit 60 determines that the reading is successful, and when the reader writer 63 cannot acquire the data, the control unit 60 determines that the reading fails.

If the reading of the data from the wireless tag 32 fails (NO in ACT 33), the control unit 60 increments the value of the counter n (n=n+1) (ACT 34). When the counter n is incremented, the control unit 60 determines whether the counter n is equal to or less than the maximum value Nmax (ACT 35). The maximum value Nmax is the maximum value of the variable n set as T(n).

If the counter n is equal to or less than Nmax (YES in ACT 35), the control unit 60 drives the feeding motor 65 in the positive direction for the T(n) time (ACT 36). Here, the feeding motor 65 is driven in the positive direction (a direction in which the ink ribbon is fed) without driving the winding motor 66. When the feeding motor 65 is driven for the T(n) time in the positive direction, the paper tube 30 provided with the wireless tag 32 and attached to the feeding shaft 10 rotates for the T(n) time in the direction (the positive direction) in which the ink ribbon is fed. When the paper tube 30 attached to the feeding shaft 10 rotates in the positive direction, the ink ribbon (the ink ribbon before use) wound around the paper tube 30 is fed. In the second operation example, since the winding motor 66 is not driven, the ink ribbon is fed without being wound around the winding shaft 12.

When the paper tube 30 rotates for the T(n) time, the positional relationship (the angle) between the wireless tag 32 and the antenna 40 changes according to the rotation amount of the paper tube 30 for the T(n) time. The control unit 60 changes the angle between the wireless tag 32 and the antenna 40 by driving the feeding motor 65 for the T(n) time, and then returns to ACT 32 to execute the data reading processing again. Accordingly, the control unit 60 can perform the data reading processing in a state in which the positional relationship between the wireless tag 32 and the antenna 40 fluctuates.

If the reading of the data from the wireless tag 32 is successful in ACT 32 (YES in ACT 33), the control unit 60 ends the data reading processing on the wireless tag 32. When the control unit 60 ends the data reading processing on the wireless tag 32, the control unit 60 rotates the feeding motor 65 in the reverse direction and performs a rewinding control for rewinding the fed ink ribbon (ACT 38).

For example, as the rewinding control, the control unit 60 rewinds the fed ink ribbon by rotating the feeding motor 65 in the reverse direction for a time for rotating the feeding motor 65 in the positive direction. As a specific example, when the reading of the data is successful after the rotation for the time T(2) (when the reading is successful at n=2), the control unit 60 rotates the feeding motor 65 in the reverse direction for the rotation time of T(1)+T(2). Accordingly, the control unit 60 can rewind the fed ink ribbon. Further, the control unit 60 may eliminate slackness of the ink ribbon by rotating the feeding motor 65 in the reverse direction and rotating the winding motor 66 in the positive direction for a short time after the rewinding control is ended.

However, the rewinding control is not limited to the method described above. For example, as the rewinding control, the control unit 60 may rewind the fed ink ribbon by rotating the feeding motor 65 in the reverse direction with a low torque caused by a low voltage for a predetermined time. In this case, the feeding motor 65 may be driven with a torque sufficient to rewind the unused ink ribbon that is fed out and to prevent the ink ribbon after use wound around the winding shaft 12 from being pulled out.

If the counter n exceeds Nmax (NO in ACT 35), the control unit 60 notifies an error (ACT 37). For example, the control unit 60 notifies the error by displaying, on the display unit 204, an error message indicating that the data cannot be read from the wireless tag 32. Even when the control unit 60 notifies the error and ends the data reading processing on the wireless tag 32, the control unit 60 performs the above-described rewinding control of the ink ribbon (ACT 38).

In the second operation example described above, when the data reading from the wireless tag 32 provided on the paper tube 30 fails, the control unit 60 of the label printer 100 rotates the feeding motor 65 for any rotation time to rotate the paper tube 30. The control unit 60 causes the reader writer 63 to execute the data reading processing on the wireless tag 32 in a state in which the paper tube 30 rotated for any rotation time is stopped. The control unit 60 repeats an operation of executing the data reading processing in a state in which the paper tube 30 rotated again for any rotation time is stopped until the data reading from the wireless tag 32 is successful.

Accordingly, the label printer 100 can change the positional relationship between the wireless tag 32 and the antenna 40 to retry the data reading processing as long as the data cannot be read from the wireless tag 32. As a result, the label printer 100 as the printing device can reliably read the data from the wireless tag 32 having any shape and any size by a simple control.

In the second operation example, when the control unit 60 of the label printer 100 acquires the data from the wireless tag 32, the control unit 60 rotates the paper tube 30 in the reverse direction by an amount corresponding to an amount of rotation of the paper tube 30 by that time. Accordingly, the ink ribbon fed for reading the data from the wireless tag 32 can be rewound onto the ribbon roll, and wasteful consumption of the ink ribbon can be prevented.

In the second operation example, when the number of times the paper tube 30 is rotated exceeds a predetermined maximum value, the control unit 60 of the label printer 100 rotates the paper tube 30 in the reverse direction by an amount corresponding to an amount of the rotation of the paper tube 30 by that time. Accordingly, the label printer 100 can stop unnecessary feeding of the ink ribbon and rewind the ink ribbon that is fed so far onto the ribbon roll. As a result, the label printer 100 as the printing device can reduce the consumption of the ink ribbon.

In the second operation example illustrated in FIG. 13 described above, the rewinding control of the ink ribbon after the data reading processing on the wireless tag 32 is ended may not be performed. Even when the rewinding of the ink ribbon is not performed, it is possible to reduce wasteful consumption of the ink ribbon even though an amount of the consumption reduction is less than that when the rewinding control is performed. In addition, there is an advantage that a printing operation can be immediately started when the rewinding control of the ink ribbon is not performed.

The embodiment described above may be applied to data reading processing on a wireless tag provided on a core material (e.g., the cylindrical body) of a label sheet roll (e.g., the medium roll), similarly to the wireless tag 32 provided on the paper tube 30. Data such as a size, a thickness, and a material of the sheet can be recorded in the wireless tag provided on the core material of the label sheet roll. An antenna 400 connected to a reader writer 63 is provided on the supply shaft 6 to which the core material of the label sheet roll provided with the wireless tag is attached, similarly to the feeding shaft 10 described above. The label printer 100 having such a configuration can acquire the data from the wireless tag 32 provided on the core material of the label sheet roll by applying the embodiment described above.

While an exemplary embodiment has been described, the embodiment has been presented by way of example and is not intended to limit the scope of the disclosure. The embodiment can be implemented in various other forms, and various omissions, substitutions, and changes can be made in a scope not departing from the gist of the disclosure. The embodiment and modifications thereof are included in the scope and the gist of the disclosure and are included in the scope of the disclosure disclosed in the claims and equivalents thereof.

What is claimed is:

1. A printing device comprising:
a shaft configured to rotatably support a roll configured to have a medium wound around a cylindrical body provided with a wireless tag;
an antenna configured to wirelessly communicate with the wireless tag;
a reader configured to read data recorded in the wireless tag by wireless communication via the antenna; and
a controller configured to, if the reader cannot read the data recorded in the wireless tag by the wireless communication via the antenna, cause the reader to perform a second read of the data recorded in the wireless tag after the cylindrical body has been rotated around the shaft for a first rotation time and has been stopped.

2. The printing device according to claim 1, wherein
the controller repeatedly causes the reader to perform subsequent reads of the data recorded in the wireless tag after the cylindrical body has been rotated around the shaft for one or more rotation times different from the first rotation time and has been stopped, until the reader successfully reads the data recorded in the wireless tag.

3. The printing device according to claim 1, further comprising:
a winding shaft configured to wind the medium fed from the medium roll supported by the shaft; and
a winding motor configured to rotate the winding shaft, wherein
the controller causes the reader to perform a third read of the data recorded in the wireless tag after the winding motor has been driven for one or more rotation times different than or same as the first rotation time and the cylindrical body rotating in response to the winding of the medium by the winding shaft has been stopped.

4. The printing device according to claim 1, further comprising:
a feed motor configured to rotate the shaft that supports the medium roll, wherein
the controller causes the reader to perform a fourth read of the data recorded in the wireless tag after the feed motor has been rotated in a positive direction for one or more rotation times different than or same as the first rotation time and rotation of the cylindrical body has been stopped.

5. The printing device according to claim 4, wherein
when the reader successfully reads the data recorded in the wireless tag, the controller further rotates the feed motor in a reverse direction by an amount corresponding to an amount of rotation of the feed motor in the positive direction.

6. The printing device according to claim 1, wherein the controller performs subsequent reads of the wireless tag for a predetermined maximum value, the predetermined maximum value comprising at least one of a rotation time or a processing time.

7. A method, comprising:
read, by one or more processors, data recorded in a wireless tag provided on a cylindrical body supported by a shaft, a printing device comprising the shaft, the shaft configured to rotatably support a roll configured to have a medium wound around the cylindrical body provided with the wireless tag; and
read, by the one or more processors, the data recorded in the wireless tag after the cylindrical body has been rotated around the shaft in response to the one or more processors being unable to read the data recorded in the wireless tag and the cylindrical body has been rotated around the shaft for a first rotation time and has been stopped.

8. The method of claim 7, wherein the one or more processors repeatedly perform subsequent reads of the data recorded in the wireless tag after the cylindrical body has been rotated around the shaft for one or more rotation times different than or same as the first rotation time and has been stopped, until the one or more processors successfully reads the data recorded in the wireless tag.

9. The method of claim 7, wherein the one or more processors perform a third read of the data recorded in the wireless tag after a winding motor included in the printing device has been driven for one or more rotation times different than or same as the first rotation time and the cylindrical body rotating in response to a winding of the medium by a winding shaft has been stopped.

10. The method of claim 7, wherein the one or more processors perform a fourth read of the data recorded in the wireless tag after a feed motor has been rotated in a positive direction for one or more rotation times different than or same as the first rotation time and rotation of the cylindrical body has been stopped.

11. The method of claim 10, wherein the one or more processors rotate the feed motor in a reverse direction by an amount corresponding to an amount of rotation of the feed motor in the positive direction in response to the one or more processors being able to successfully read the data recorded in the wireless tag.

12. The method of claim 7, wherein the one or more processors performs subsequent reads of the wireless tag for a predetermined maximum value, the predetermined maximum value comprising at least one of a rotation time or a processing time.
